(19) United States
(12) Patent Application Publication
(10) Pub. No.: US 2026/0078855 A1
(43) Pub. Date: Mar. 19, 2026

(54) EXHAUST PIPE ASSEMBLY FOR A GAS-POWERED ELECTRIC GENERATOR

(71) Applicant: Randy Minniefield, Victorville, CA (US)

(72) Inventor: Randy Minniefield, Victorville, CA (US)

(21) Appl. No.: 18/889,060

(22) Filed: Sep. 18, 2024

(51) Int. Cl. F16L 23/02; F16L 9/02

(52) U.S. Cl. CPC F16L 41/086; F01N 13/1805

(57) ABSTRACT

An exhaust pipe assembly for a gas-powered electric generator includes a pipe and a connector. The pipe includes a first pipe portion and a second pipe portion transverse to the first pipe portion. The first pipe portion includes an input opening and the second pipe portion includes an output opening. The connector is positioned at the input opening of the first pipe portion and designed to be detachably connected to a gas-powered electric generator to operatively connect the input opening to an exhaust port of the gas-powered electric generator. The connector is designed to orient the second pipe portion in a substantially vertical direction to guide exhaust gases upwardly and away from structures adjacent sides of the gas-powered electric generator.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to exhaust pipes for generators and more particularly pertains to a new exhaust pipe assembly for venting exhaust from gas-powered electric generators. As is well known, gas-powered electric generators produce hot exhaust gases that are vented through an exhaust port horizontally out of a side of the gas-powered electric generator. Usually, this venting is not an issue because the exhaust gases are vented out into an open space. However, in some instances the generator is located near another object that the hot exhaust gases could damage. For example, it is not uncommon for users to utilize the generator in the bed of a pickup truck or other vehicle or adjacent outdoor equipment during camping trips or similar outdoor activities. In such a situation, the hot exhaust gases could damage the sides of the bed of the pickup truck. The present invention vents the exhaust gases in a vertical direction away from the generator and any objects near the sides of the generator and in the path of the exhaust gases.

### (2) Description of Related Art Including Information Disclosed Under 37 CFR 1.97 and 1.98.

The prior art relates to exhaust pipes for generators. The prior art, as best understood, does not disclose an exhaust pipe assembly for a gas-powered electric generator that includes a pipe and a connector, wherein the connector is designed to be detachably connected to a gas-powered electric generator to operatively connect the pipe to an exhaust port of the gas-powered electric generator, wherein the connector is further designed to orient the second pipe portion in a substantially vertical direction to guide exhaust gases upwardly and away from structures adjacent sides of the gas-powered electric generator.

### BRIEF SUMMARY OF THE INVENTION

An embodiment of the disclosure meets the needs presented above in an exhaust pipe assembly for a gas-powered electric generator generally comprising a pipe and a connector. The pipe includes a first pipe portion and a second pipe portion transverse to the first pipe portion. The first pipe portion includes an input opening and the second pipe portion includes an output opening. The connector is positioned at the input opening of the first pipe portion and designed to be detachably connected to a gas-powered electric generator to operatively connect the input opening to an exhaust port of the gas-powered electric generator. The connector is designed to orient the second pipe portion in a substantially vertical direction to guide exhaust gases upwardly and away from structures adjacent sides of the gas-powered electric generator.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an exhaust pipe assembly according to an embodiment of the disclosure.

FIG. 2 is an exploded view of an embodiment of the disclosure.

FIG. 3 is a perspective view of an embodiment of the disclosure in use.

FIG. 4 is a perspective view of an embodiment of the disclosure.

### DETAILED DESCRIPTION OF THE INVENTION

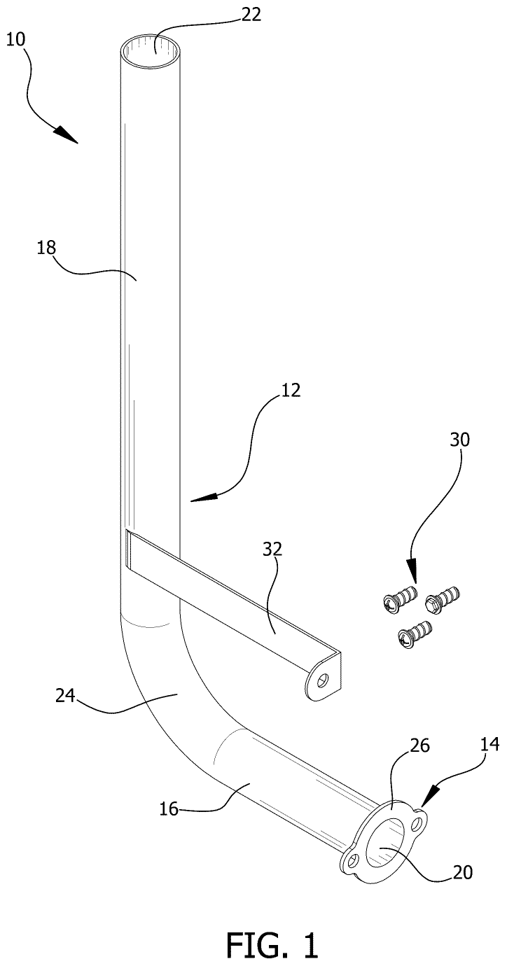

With reference now to the drawings, and in particular to FIGS. 1 through 4 thereof, a new exhaust pipe assembly embodying the principles and concepts of an embodiment of the disclosure and generally designated by the reference numeral 10 will be described.

As best illustrated in FIGS. 1 through 4, the exhaust pipe assembly 10 generally comprises a pipe 12 and a connector 14. The pipe 12 includes a first pipe portion 16 and a second pipe portion 18 transverse to the first pipe portion 16. The first pipe portion 16 includes an input opening 20 and the second pipe portion 18 includes an output opening 22. The connector 14 is positioned at the input opening 20 of the first pipe portion 16 and designed to be detachably connected to a gas-powered electric generator to operatively connect the input opening 20 to an exhaust port of the gas-powered electric generator. The connector 14 is designed to orient the second pipe portion 18 in a substantially vertical direction to guide exhaust gases upwardly and away from structures adjacent sides of the gas-powered electric generator.

The pipe 12 includes a third pipe portion 24 connecting the first pipe portion 16 and the second pipe portion 18. The third pipe portion 24 is curved sufficiently to orient the second pipe portion 18 at essentially a right angle to the first pipe portion 16. In another possible embodiment, the third pipe portion 24 could be an angled piece. The second pipe portion 18 and the first pipe portion 16 can be oriented at 90 degrees, though angles of anywhere from about 75 degrees to about 105 degrees could be suitable to direct the exhaust gases upwardly. Regardless of the exact angular relationship, in the exemplary embodiment, the second pipe portion 18 is designed to extend beyond, or possibly to, an uppermost portion of a gas-powered electric generator when installed. For example, the second pipe portion 18 could be in the range of 15 inches to 25 inches in length to promote a high venting position away from the generator and adjacent objects or people.

In one possible embodiment, the pipe 12 is made of galvanized steel, though other metals, such as aluminum, could be used. In one possible embodiment, the pipe 12 could be made of heat-resistant plastics or ceramics. In another possible embodiment, the pipe 12 includes a heat-resistant coating, which could have a black color or other suitable color.

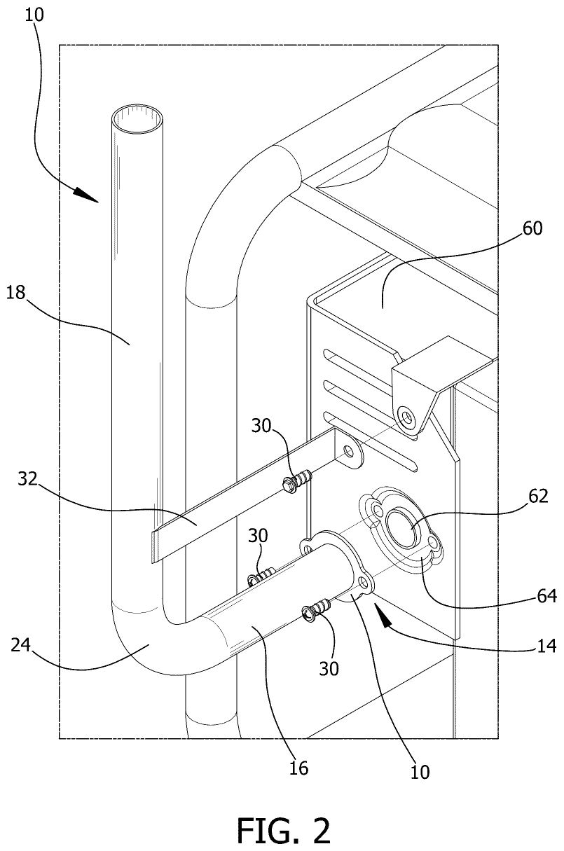

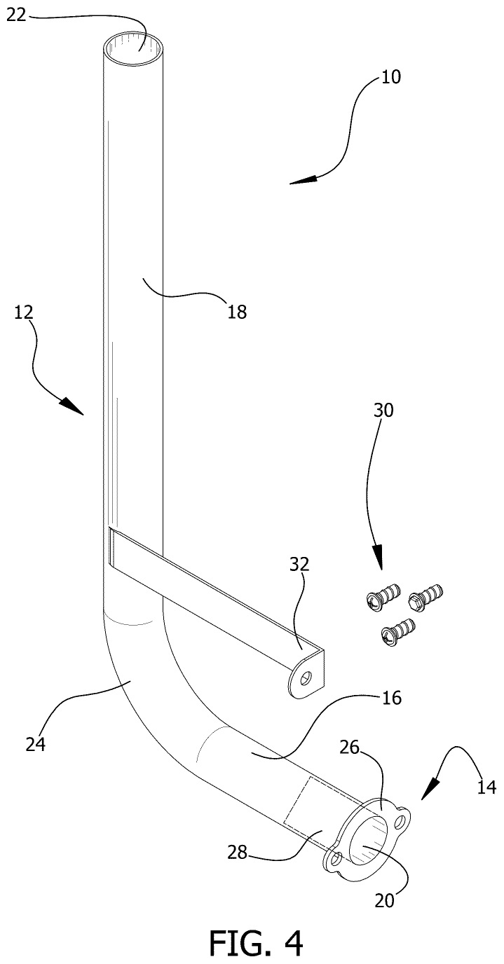

As shown in FIG. 2, the connector 14 includes a flange 26 designed to be placed against a surface surrounding an exhaust port of the gas-powered electric generator. In one possible embodiment, the flange 26 is attached to the first pipe portion 16. In another possible embodiment shown in FIG. 4, the connector 14 includes a connecting pipe 28 attached to the flange 26 like a manifold. The connecting pipe 28 is removably insertable into the first pipe portion 16. As shown in the figures, the flange 26 is connectable by screws or bolts 30, though other connecting structures are within the scope of the disclosure, such as snap-fits or pop rivets.

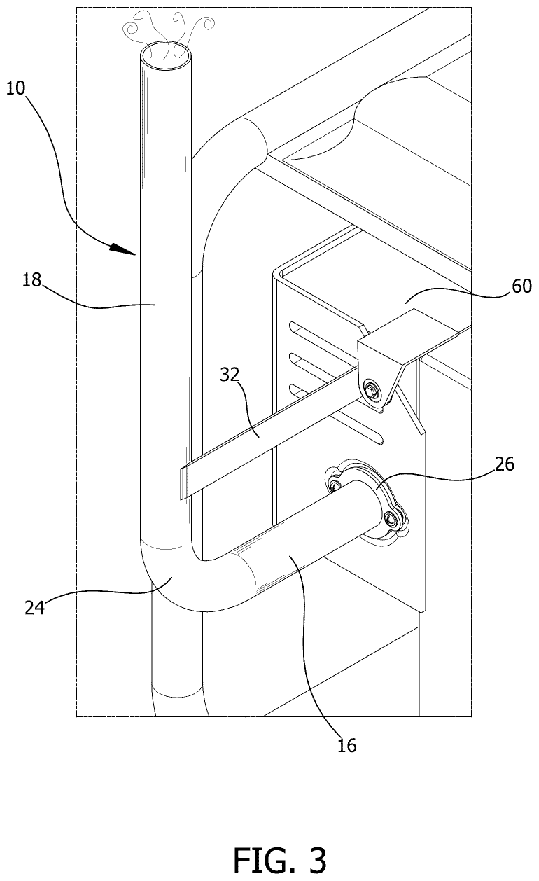

In the exemplary embodiment shown in FIG. 1, the exhaust pipe assembly 10 further includes a support structure 32 attached to the second pipe portion 18 and designed to be detachably connected to a gas-powered electric generator to stabilize the second pipe portion 18, such as shown in FIGS. 2 and 3. The support structure 32 is in the form of a bracket extending transversely from the second pipe portion 18. As shown in the figures, like the flange 26, the support structure 32 is connectable by screws or bolts 30, though other connecting structures are within the scope of the disclosure, such as snap-fits or pop rivets.

As shown in FIGS. 2 and 3, the exhaust pipe assembly 10 is detachably connected by placing the flange 26 against a surface 64 surrounding an exhaust port 62 of a gas-powered electric generator 60, and then inserting the screws or bolts 30 through the flange 26 and into the surface 64. The exhaust pipe assembly 10 passively vents exhaust gases produced by the gas-powered electric generator 60 in a vertical direction, thereby allowing placement of the generator 60 adjacent structures, such as the sides of a bed of a pickup truck, without risking damage to such structures. Since the exhaust pipe assembly 10 is detachably connected to the gas-powered electric generator 60, a user can remove the exhaust pipe assembly 10 for transport.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An exhaust pipe assembly for a gas-powered electric generator comprising:
a pipe comprising a first pipe portion and a second pipe portion transverse to said first pipe portion, wherein said first pipe portion comprises an input opening and said second pipe portion comprises an output opening; and
a connector disposed at said input opening of said first pipe portion and configured be detachably connected to a gas-powered electric generator to operatively connect said input opening to an exhaust port of the gas-powered electric generator, wherein said connector is configured to orient said second pipe portion in a substantially vertical direction to guide exhaust gases upwardly and away from structures adjacent sides of the gas-powered electric generator.

2. The exhaust pipe assembly of claim 1, wherein said pipe comprises a third pipe portion connecting said first pipe portion and said second pipe portion, wherein said third pipe portion is curved.

3. The exhaust pipe assembly of claim 2, wherein said third pipe portion is sufficiently curved to orient said second pipe portion at essentially a right angle to said first pipe portion.

4. The exhaust pipe assembly of claim 1, wherein said pipe comprises galvanized steel.

5. The exhaust pipe assembly of claim 1, wherein said pipe comprises a heat-resistant coating.

6. The exhaust pipe assembly of claim 1, wherein said second pipe portion is configured to extend beyond an uppermost portion of a gas-powered electric generator when installed.

7. The exhaust pipe assembly of claim 1, wherein said connector comprises a flange configured to be placed against a surface surrounding an exhaust port of the gas-powered electric generator.

8. The exhaust pipe assembly of claim 1, wherein said flange is attached to said first pipe portion or said connector comprises a connecting pipe attached to said flange and removably insertable into said first pipe portion.

9. The exhaust pipe assembly of claim 1, wherein the exhaust pipe assembly further comprises a support structure attached to said second pipe portion and configured to be detachably connected to a gas-powered electric generator to stabilize said second pipe portion.

10. The exhaust pipe assembly of claim 9, wherein said support structure comprises a bracket extending transversely from said second pipe portion.

11. The exhaust pipe assembly of claim 1, wherein:
said pipe comprises a third pipe portion connecting said first pipe portion and said second pipe portion, wherein said third pipe portion is curved;
said third pipe portion is sufficiently curved to orient said second pipe portion at essentially a right angle to said first pipe portion;
said pipe comprises galvanized steel;
said pipe comprises a heat-resistant coating;
said second pipe portion is configured to extend beyond an uppermost portion of a gas-powered electric generator when installed; and
said connector comprises a flange configured to be placed against a surface surrounding an exhaust port of the gas-powered electric generator.

12. The exhaust pipe assembly of claim 11, wherein:
the exhaust pipe assembly further comprises a support structure attached to said second pipe portion and configured to be detachably connected to a gas-powered electric generator to stabilize said second pipe portion; and
said support structure comprises a bracket extending transversely from said second pipe portion.

13. The exhaust pipe assembly of claim 12, wherein said flange is attached to said first pipe portion.

14. The exhaust pipe assembly of claim 12, wherein said connector comprises a connecting pipe attached to said flange and removably insertable into said first pipe portion.
